(19) United States
(12) Patent Application Publication
(10) Pub. No.: US 2008/0000117 A1
(43) Pub. Date: Jan. 3, 2008

(54) Check Presenter with View Window

(75) Inventors: Norman Paul Marshall JR., Greensboro, NC (US); Randi Schochet, Tarrytown, NY (US); Sharron Walker, North Hollywood, CA (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/769,587

(22) Filed: Jun. 27, 2007

Related U.S. Application Data
(60) Provisional application No. 60/816,632, filed on Jun. 27, 2006.

(51) Int. Cl. G09F 3/00

(52) U.S. Cl. 40/124.06

(57) ABSTRACT

A check presenter allows a merchant to provide customizable promotional offers to their customers. In embodiments of such check presenters, an edge of a substantially planar first panel having opposing first and second faces is joined to a substantially planar second panel having opposing third and fourth faces by a flexible hinge. A pocket is formed between the first and second faces of the first panel, and the first panel has a window formed in the first face coincident with at least a portion of the pocket. Promotional material may be disposed within the pocket and may be visible through the window. The promotional material may be customized for a customer based on at least one of an identity of the customer, a purchase made by the customer, and an amount spent by the customer. Alternatively, information identifying a merchant is visible through the window, including a name of the merchant and a logo of the merchant.

### CROSS-REFERENCE TO RELATED APPLICATIONS

This application claims priority to, and the benefit of, U.S. Provisional Patent Application No. 60/816,632, filed Jun. 27, 2006, which is hereby incorporated by reference in its entirely.

### BACKGROUND

1. Field of the Invention

This invention generally relates to check presenters, and in particular, it relates to check presenters used by merchants to present invoices to customers.

2. Background Art

Merchants such as restaurants, spas, and salons, and tradesman, such as electricians and plumbers, often present a check (i.e., an invoice or bill) to a customer in a bi-fold folder or check presenter. Such check presenters typically include an inner sleeve configured to hold the check in place. The customer opens the folder to inspect the check, inserts a form of payment (e.g., cash, a credit card, or a charge card), and returns the check presenter to the merchant.

Merchants often provide promotional offers to their customers to build customer loyalty and to increase sales volume. However, existing check presenters are generally ineffective mechanisms for providing promotional materials to customers. Except for those brief periods during which the customer inspects the check and provides payment, check presenters generally remain in a closed position. As such, promotional material placed within these existing check presenters may be visible to the customer only during those brief periods when the customer's attention is directed elsewhere, i.e., reviewing the bill and providing payment.

Further, there is often insufficient space within existing check presenters to present promotional offers in an attractive manner that captures the attention of the customer. Merchants often resort to placing promotional materials into inner sleeves that are configured to support only checks, invoices, and/or bills. The promotional material often deforms these inner sleeves, and in some instances, detaches the inner sleeves from the check presenter.

### BRIEF SUMMARY OF THE INVENTION

The present disclosure introduces a check presenter with a window for viewing promotional materials. The check presenter of the invention allows, for example, a merchant, such as a restaurant, to provide promotional offers to its customers

According to various embodiments, the disclosed check presenter comprises a substantially planar first panel having opposing first and second faces and a substantially planar second panel having opposing third and fourth faces. A pocket is formed between the first and second faces, and the first panel has a window formed in the first face that is coincident with at least a portion of the pocket. A flexible hinge joins an edge of the first panel to an edge of the second panel and allows relative movement of the first panel with respect to the second panel about the hinge to define a closed position and an open position.

Promotional material may be disposed within the pocket and may be visible through the window. The promotional material may be customized for a customer based on at least one of an identity of the customer, a purchase made by the customer, and an amount spent by the customer. Further, information identifying a merchant, such as a name of the merchant and a logo associated with the merchant, may be visible through the window.

Further features and advantages of the present invention as well as the structure and operation of various embodiments of the present invention are described in detail below with reference to the accompanying drawings.

### BRIEF DESCRIPTION OF THE DRAWINGS/FIGURES

The features and advantages of the present invention will become more apparent from the Detailed Description set forth below when taken in conjunction with the drawings in which like reference numbers indicate identical or functionally similar elements. Additionally, the left-most digit of a reference number identifies the drawing in which the reference number first appears.

FIG. 1 is a perspective view of an exemplary check presenter according to an embodiment of the present invention.

FIG. 2 is a second perspective view of the exemplary check presenter of FIG. 1.

FIG. 3 is a third perspective view of the exemplary check presenter of FIG. 1.

FIG. 4 is a plan view of the exemplary check presenter of FIG. 1.

FIG. 5 is a second plan view of the exemplary check presenter of FIG. 1.

### DETAILED DESCRIPTION OF THE INVENTION

Embodiments of the present invention are now described with reference to the figures. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

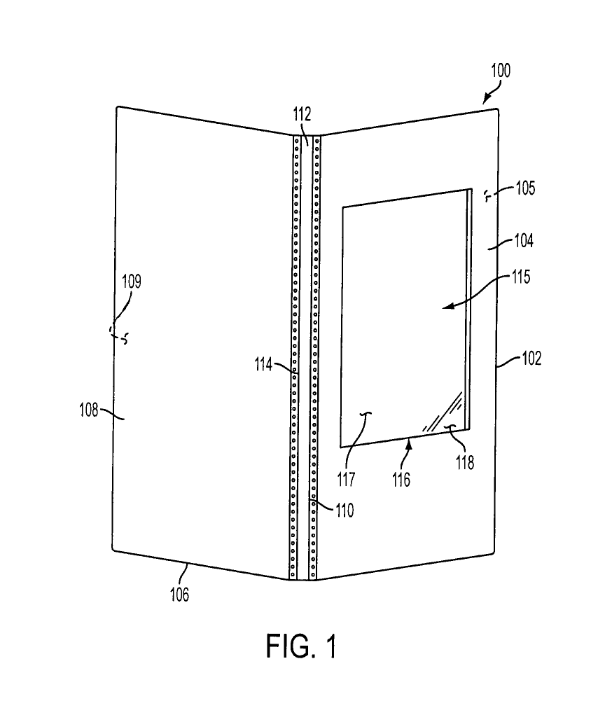

FIG. 1 is a perspective view of an exemplary check presenter 100 disposed in an open position according to an embodiment of the present invention. In FIG. 1, an edge 110 of a substantially-planar first panel 102 is joined to an edge 114 of a substantially-planar second panel 106 by a flexible hinge 112. First panel 102 has a first face 104 that is disposed opposite to a second face 105 (not visible in FIG. 1), and second panel 106 has a third face 108 disposed opposite a fourth face 109 (not visible in FIG. 1). Relative movement of first panel 102 with respect to second panel 106 about flexible hinge 112, which results in a rotation of second face 105 of first panel 102 away from fourth face 109 of second panel 106, defines the open position of check presenter 100.

In one embodiment, a pocket 115 is formed in first panel 102 between first face 104 and second face 105. A window 116 is formed in first face 104.

Window 116 is coincident with at least a portion of pocket 115 within first panel 102. As shown in FIG. 1, a pocket wall 117 (i.e., the backside of second face 105) is visible through window 116. Further, a transparent sheet 118 covers window 116. Transparent sheet 118 may shield pocket 115 from contamination, for example, by dust and/or liquids.

In one embodiment, promotional materials (not shown) may be positioned within pocket 115 so as to be visible through window 116 and transparent sheet 118. In additional embodiments, information (such as a logo or other information identifying a merchant) may be printed onto pocket wall 117 such that it is visible through window 116 when no promotional material is present in pocket 115.

Examples of promotional materials include, without limitation, advertisements, discount offers, inducements, logos, business names, incentives, and the like.

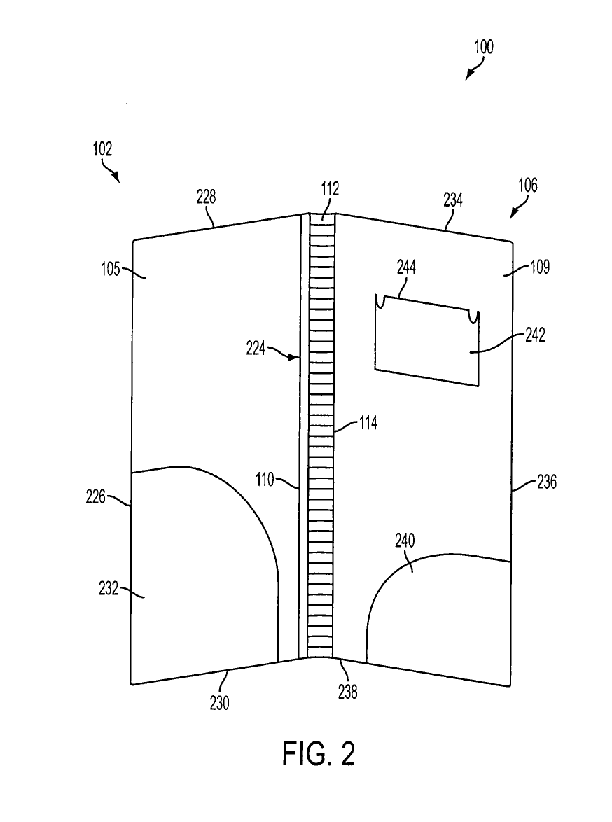

FIG. 2 is a second perspective view of the exemplary check presenter 100 in an open position. As was described with reference to FIG. 1, edge 110 of first panel 102 is joined to edge 114 of second panel 106 by flexible hinge 112. Further, the open position of check presenter 100 is defined by the relative movement of first panel 102 with respect to second panel 106 about flexible hinge 112, which results in a rotation of second face 105 away from fourth face 109.

An elongated opening 224 in first panel 102 allows promotional materials to be slid or slipped into pocket 115 within first panel 102. Once positioned within pocket 115, the material would be visible through window 116 in first face 104 (not shown in FIG. 2).

In one embodiment, first panel 102 is formed from a substantially planar, inner, stiffening member (not shown) such as cardboard, fiberboard, plastic, metal, etc. that is covered with a flexible sheet material such as plastic, leather, etc. For example, plastic sheet material can be used to form a flexible covering over the stiffening member. The plastic materially can be thermally sealed along edges 226, 228, and 230. The plastic material can remain unsealed along edge 110 to form elongated opening 224. In an alternate embodiment, the plastic material may be sealed at edge 110 and a cut or incision can be made to form elongated opening 224.

Second panel 106 is formed in a similar manner as first panel 102 but need not include opening 224. In an alternate embodiment, however, second panel 106 may be similar to first panel 102 and include an inner pocket and window formed in face 108. In this alternate embodiment, second panel 106 would include an opening 224 for gaining access to the inner pocket.

In one embodiment, check presenter 100 may be formed by heat sealing plastic sheet material around two stiffeners arranged in a side-by-side fashion. In this embodiment, a heat seal of the plastic sheet material between the two stiffeners can form the hinge.

As shown in FIG. 2, a sleeve 232 is disposed on second face 105 and attached to second face 105 along edges 226 and 230. Further, sleeves 240 and 242 are disposed on fourth face 109. Sleeve 240 is attached to fourth face 109 along edges 236 and 238, and sleeve 242 may be attached to fourth face 222 such that an edge 244 of sleeve 242 remains detached from fourth face 222. Sleeves 232, 240, and 242 may house a number objects, including, but not limited to, a financial transaction instrument. As the term is used herein, a “financial transaction instrument” is an instrument related to a financial transaction account and includes, for example, transaction cards such as credit, charge, debit, pre-paid and stored-value cards, or any other similar financial transaction instrument. The sleeves may also hold other instruments related to a financial transaction including, for example, currency (including cash and coins); a check, invoice or bill; or a receipt or other record of transaction.

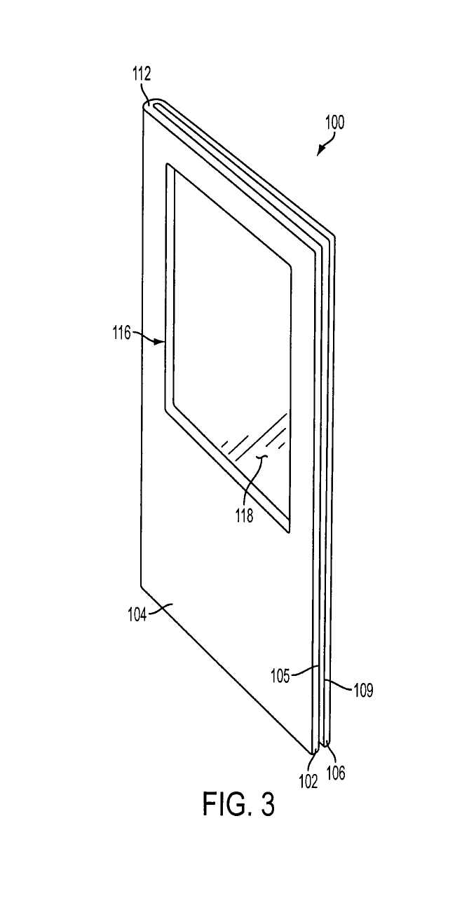

FIG. 3 is a perspective view of the exemplary check presenter 100 in a closed position. In FIG. 3, relative movement of first panel 102 with respect to second panel 106 about flexible hinge 112 defines the closed position of check presenter 100. In the closed position, second face 105 of first panel 102 is positioned adjacent to, and substantially parallel with, fourth face 109 of second panel 106. Further, material within pocket 115 formed between first face 104 and second face 105 is visible through window 116 and transparent sheet 118.

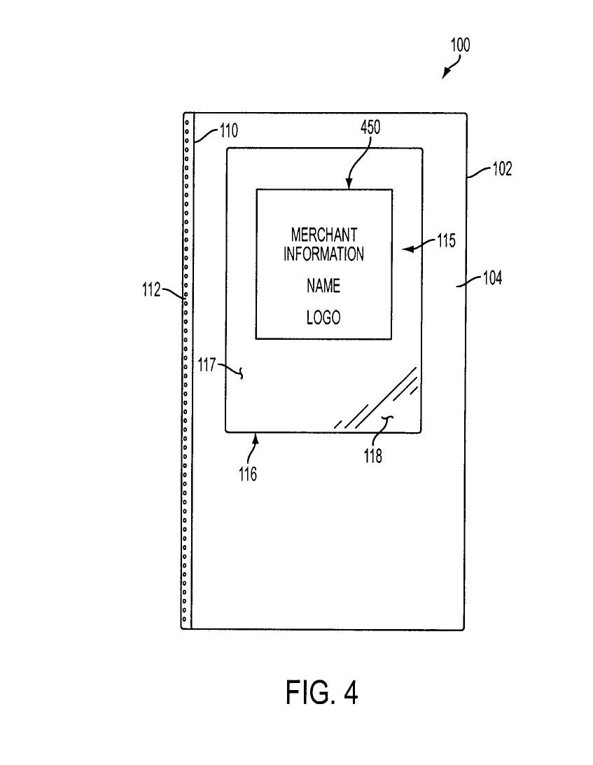

FIG. 4 is a plan view of the exemplary check presenter 100 in a closed position. In FIG. 4, first panel 102 of check presenter 100 is joined with second panel 106 (not shown in FIG. 4) along edge 110 by flexible hinge 112. Further, window 116 forms a portion of first face 104, and transparent sheet 118 covers window 116.

In the embodiment of FIG. 4, information 450 identifying a merchant associated with check presenter 100 is viewable through window 116 and transparent sheet 118. Information 450 may include, but is not limited to, a logo associated with the merchant and a name of the merchant. Information 450 may be printed directly onto pocket wall 117 such that information 450 is viewable through window 116. Additionally, information 450 may be displayed on removable material (e.g., paper) that may be positioned within pocket 115 such that information 450 is viewable through window 116.

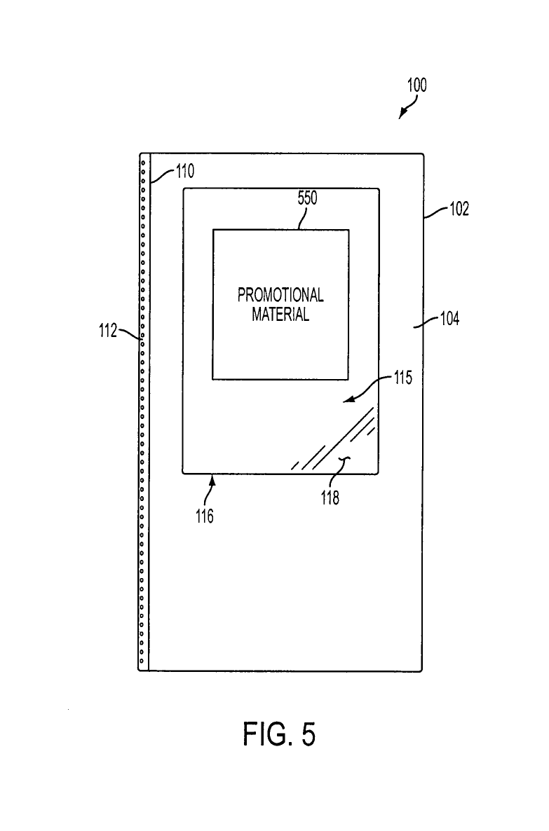

FIG. 5 is a second plan view of the exemplary check presenter 100 in a closed position. In the embodiment of FIG. 5, however, promotional material 550 is positioned within pocket 115. In one embodiment, promotional material 550 may be placed into pocket 115 through elongated opening 224, as was described above in reference to FIG. 2. Promotional material 550 is viewable through window 116.

Promotional material 550 may be tailored to a particular customer based, for example, on an identity of the customer, a particular purchase or set of purchases made by the customer, and a particular amount spent by the customer.

In one embodiment, a number of check presenters, such as check presenter 100, may be loaded with predetermined promotional offers, and the merchant may select a specific combination of check presenter and promotional offer based on a particular customer order. In an additional embodiment, the merchant may be a loyalty point program partner (e.g., Membership Rewards® from American Express®), and a qualifying use of a financial transaction account of the customer (e.g., credit card or charge card) at that merchant may trigger an immediate reward redemption that may be printed by the merchant and presented to the customer using check presenter 100. These examples of promotional material 550 are provided for illustrative purposes only, and are not limiting to the present invention. A number of additional promotional offers may be tailored to a customer and/or merchant and presented to the customer using check presenter 100.

In another embodiment of the invention, second panel 106 supports a writing surface when the presenter is in a closed position. In this embodiment, a writing surface, such as a notepad or a notebook, may be temporarily or permanently disposed on third face 108 of second panel 106. Additionally, a re-usable writing surface, such as a dry-erase surface, may form at least a portion of third face 108 or may be disposed on third face 108. For example, a waiter or waitress of a restaurant may use an order pad affixed to third face 108 to record orders from customers of the restaurant. Using the embodiments described above, customers of the restaurant would be able to view promotional materials, such as promotional material 550 described above with reference to FIG. 5, while the waiter or waitress records their orders.

In yet another embodiment of the invention, the presenter includes only first panel 102 and does not include second panel 106. In this embodiment, a check or other instrument relating to the financial transaction can be presented to a customer or to a seller/vender by placing the check or other instrument in sleeve 232. Furthermore, the size of sleeve 232 can be increased to provide additional capacity. Still further, additional sleeves may be added to face 105 to provide additional holding capability.

IV. Conclusion

The disclosed check presenter provides an attractive, efficient, and durable mechanism through which merchants may deliver special promotions to their customers. The present invention improves upon existing check presenters by providing a viewing window through which a customer may view promotional material and/or information identifying the merchant.

The disclosed check presenter allows merchants to display promotional materials to their customers in an attractive and efficient manner By providing these promotional materials to their customers, merchants may encourage customer loyalty and may experience an increased transaction volume. The providers of financial transaction instruments (such as credit cards) benefit from an increased volume of transactions involving the financial transaction instruments, and further, the promotional offers may serve to increase loyalty to the particular financial transaction instrument (e.g., credit card).

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A check presenter comprising:
a substantially planar first panel having opposing first and second faces, wherein a pocket is formed between the first and second faces, wherein the first panel has a window formed in the first face coincident with at least a portion of the pocket;
a substantially planar second panel having opposing third and fourth faces; and
a flexible hinge joining an edge of the first panel to an edge of the second panel, the hinge allowing relative movement of the first panel with respect to the second panel about the hinge to define a closed position wherein the second face of the first panel is positioned adjacent to, and substantially parallel with, the fourth face of the second panel, and an open position wherein the second face of the first panel is rotated away from the fourth face of the second panel.

2. The check presenter of claim 1, further comprising a transparent sheet covering at least a portion of the window.

3. The check presenter of claim 1, further comprising a sleeve disposed on at least one of (i) the second surface of the first panel and (ii) the third surface of the second panel, wherein the sleeve is configured to receive at least one of an invoice and a financial transaction instrument.

4. The check presenter of claim 1, wherein information identifying a merchant is visible in the window.

5. The check presenter of claim 4, wherein the information comprises at least one of (i) a name of the merchant and (ii) a logo of the merchant.

6. The check presenter of claim 1, further comprising promotional material disposed within the pocket and visible through the window.

7. The check presenter of claim 6, wherein the promotional material is customized for a customer based on at least one of (i) an identity of the customer, (ii) a purchase made by the customer, and (iii) an amount spent by the customer.

8. The check presenter of claim 6, wherein the promotional material is selected from a pre-determined set of promotional materials based upon at least one of (i) an identity of a customer, (ii) a purchase made by a customer, and (iii) an amount spent by a customer.

9. The check presenter of claim 6, wherein the promotional material is customized for a customer based on a financial transaction instrument provided by the customer.

10. The check presenter of claim 1, wherein the first panel comprises an elongated opening at an edge of the first panel to allows paper to be slid into the pocket.

11. The check presenter of claim 1, wherein the second panel comprises a second pocket formed between the third and fourth faces, wherein the second panel has a second window formed in the fourth face coincident with at least a portion of the second pocket.

12. An apparatus for presenting an instrument related to a financial transaction, comprising:
a substantially planar panel having opposing first and second faces, wherein a pocket is formed between the first and second faces, wherein the panel has a window formed in the first face coincident with at least a portion of the pocket;
an elongated opening in the panel to allow introduction of printed material into the pocket; and
at least one sleeve formed on the second face of the panel for holding the instrument.

13. The apparatus of claim 12, further comprising a transparent sheet covering at least a portion of the window.

14. The apparatus of claim 12, wherein information identifying a merchant is visible in the window.

15. The apparatus of claim 14, wherein the information comprises at least one of (i) a name of the merchant and (ii) a logo of the merchant.

16. The apparatus of claim 12, further comprising promotional material disposed within the pocket and visible through the window.

17. The apparatus of claim 12, further comprising:
a substantially planar second panel having opposing third and fourth faces; and
a flexible hinge joining an edge of the first panel to an edge of the second panel, the hinge allowing relative movement of the first panel with respect to the second panel about the hinge to define a closed position wherein the second face of the first panel is positioned adjacent to, and substantially parallel with, the fourth face of the second panel, and an open position wherein the second face of the first panel is rotated away from the fourth face of the second panel.

18. A check presenter comprising:
a substantially planar first panel having opposing first and second faces, wherein a pocket is formed between the first and second faces, wherein the first panel has a window formed in the first face coincident with at least a portion of the pocket;
a substantially planar second panel having opposing third and fourth faces; and
a flexible hinge joining an edge of the first panel to an edge of the second panel, the hinge allowing relative movement of the first panel with respect to the second panel about the hinge to define a closed position wherein the second face of the first panel is positioned adjacent to, and substantially parallel with, the fourth face of the second panel, and an open position wherein the second face of the first panel is rotated away from the fourth face of the second panel,
wherein the substantially planar second panel supports a writing surface when the check presenter is in the closed position.

19. The check presenter of claim 18, wherein the writing surface forms at least a portion of the third face of the second panel.

20. The check presenter of claim 18, wherein the writing surface is disposed on the third face of the second panel.
